(19) United States
(12) Patent Application Publication
(10) Pub. No.: US 2025/0353753 A1
(43) Pub. Date: Nov. 20, 2025

(54) PREPARATION OF A SODIUM SILICATE SUITABLE FOR A PRECIPITATED SILICA PROCESS FROM SERPENTINE LEACHING RESIDUAL SILICA

(71) Applicant: ALLIANCE MAGNÉSIUM, Danville (CA)

(72) Inventors: Colin DESSEMOND, Sherbrooke (CA); Joël FOURNIER, Carignan (CA); Jonathan VIENS, Sherbrooke (CA); Jonathan COUTURE, Sherbrooke (CA)

(21) Appl. No.: 18/872,897

(22) PCT Filed: Jun. 22, 2023
(86) PCT No.: PCT/CA2023/050871

§ 371 Date: Dec. 9, 2024

Related U.S. Application Data
(60) Provisional application No. 63/366,883, filed on Jun. 23, 2022.

(51) Int. Cl. C01B 33/32

(52) U.S. Cl. CPC C01B 33/32; C01P 2004/61

(57) ABSTRACT

It is provided a process for producing sodium silicate comprising the steps of pretreating residual SiO₂ silica; homogenizing the pretreated residual SiO₂ silica with a mixture of H₂O—NaOH producing a mixture of NaOH/SiO₂; heating the mixture of NaOH/SiO₂; obtaining a sodium silicate (Na₂O)x(SiO₂)y; diluting the sodium silicate (Na₂O)x(SiO₂)y in water producing a sodium silicate diluted solution (Na₂O)x(SiO₂)y; filtering the diluted solution (Na₂O)x(SiO₂)y to remove impurities.

### CROSS-REFERENCE TO RELATED APPLICATION

The present application is claiming priority from U.S. Provisional Application No. 63/366,883 filed Jun. 23, 2022, the content of which is hereby incorporated by reference in their entirety.

### TECHNICAL FIELD

It is described a process for producing silica sodium silicate suitable for a precipitated silica process from residual SiO₂ silica recovered from serpentine leaching.

### BACKGROUND

Silica (SiO₂) is the major constituent of sand. It is used in structural materials, microelectronics (as an electrical insulator), and as components in the food and pharmaceutical industries, particularly of importance in semiconductor technologies. Silica is mostly obtained by mining, including sand mining and purification of quartz. Chemical and/or physical processing is needed to produce a purer or otherwise more suitable (e.g. more reactive or fine-grained) product.

Precipitated silica is produced synthetically, particularly through a reaction between a sodium silicate solution and a mineral acid. Both react under controlled conditions to produce silica in a precipitated form with a set of desired properties such as specific surface area, size, pore size, etc. Sodium silicate Na₂ₓSi_{y}O_{2y+x} or (Na₂O)ₓ(SiO₂)_{y} is normally produced at elevated temperature (around 1200 to 1400° C.) by reacting crystalline silica (SiO₂), often in the form of silica sand, with sodium carbonate (Na₂CO₃). This process is expensive because of the large quantity of energy required and the cost of the reagents, and further releases CO₂ which is not desired.

As an alternative raw material, magnesium silicate ore can be used to produce amorphous silica. For example, serpentine contains approximately 40 percent SiO₂. Serpentine is a family of mineral silicates. The three most important serpentine polymorphs are lizardite, antigorite and chrysotile which is a form of asbestos. These all have essentially the same chemistry, but they differ in their structures.

Large quantities of serpentine are available in North America from the asbestos industry. Over the years, mountains of tailings, mainly lizardite Mg₃Si₂O₅(OH)₄, have accumulated. These tailings can also contain other minor components such as Mg(OH)₂, NisFe₃, Fe₃O₄, etc. Such deposits represent an excellent, natural resource, easily available.

Activated silica can be produced by leaching magnesium silicate ore in hydrochloric acid media as described in GB 2 078 703. A material with a specific surface area of approximately 220 m²/g was achieved. During this hydrometallurgical process, the soluble portion passes in solution leaving behind the SiO₂ phase along with other insoluble impurities. After this extraction step, silica is separated from the solution and washed. An additional cleaning step is necessary and it involves the separation of unreacted material by a physical method such as a shaker table. However, the level of impurities remains relatively high. This material is then dried, before or after a grinding operation, under conditions favoring the removal of moisture, whereas the chemically bound water is retained.

WO 2016/176772 describes a process of producing amorphous silica from serpentine, comprising the steps of mixing the raw material with a hydrochloric acid solution, leaching the raw material obtaining a slurry comprising a liquid fraction and a solid fraction containing silica and minerals, removing the minerals from the solid fraction by magnetic separation producing a purified solid silica, and heating the purified solid silica to remove hydroxyl groups from the silica surface and reducing specific surface area of the resulting amorphous silica.

It is still desirable to be provided with new processes for the production of pure silica.

### SUMMARY

It is provided a process for producing a sodium silicate comprising the steps of pretreating residual SiO₂ silica; homogenizing the pretreated residual SiO₂ silica with NaOH producing a mixture of NaOH/SiO₂; heating the mixture of NaOH/SiO₂; obtaining sodium silicate (Na₂O)ₓ(SiO₂)_{y}; diluting the sodium silicate (Na₂O)ₓ(SiO₂)_{y} in water producing a sodium silicate diluted solution (Na₂O)ₓ(SiO₂)_{y} and filtering the sodium silicate diluted solution (Na₂O)ₓ(SiO₂)_{y} to remove impurities.

In an embodiment, the sodium silicate is suitable for a precipitated silica process.

In another embodiment, the residual SiO₂ silica is pretreated by homogenization.

In a further embodiment, the residual SiO₂ silica is further grinded.

In an embodiment, the residual SiO₂ silica is grinded to a size of about 50 μm.

In another embodiment, the homogenized SiO₂ silica is mixed with NaOH so that the SiO₂: Na₂O ratio is between 0.5:1 and 3.5:1.

In a further embodiment, the NaOH/SiO₂ mixture is heated between 80° C. and 120° C. for 60 to 120 min.

In another embodiment, the filtered the sodium silicate diluted solution is further washed with water.

In another embodiment, the sodium silicate is recovered in the form of an aqueous solution.

In a further embodiment, the residual SiO₂ silica is provided from a magnesium extraction process.

In another embodiment, the residual SiO₂ silica is provided from a magnesium extraction process from serpentine.

### BRIEF DESCRIPTION OF THE DRAWINGS

Reference will now be made to the accompanying drawings.

FIG. 1 illustrates a schematic representation of the provided process for the production of a sodium silicate as encompassed herein.

It will be noted that throughout the appended drawings, like features are identified by like reference numerals.

### DETAILED DESCRIPTION

It is provided a process for producing silica sodium silicate from residual SiO₂ silica.

Accordingly, it is provided a process for producing sodium silicate comprising the steps of isolating residual SiO₂ silica from serpentine; homogenizing the pretreated residual SiO₂ silica with NaOH producing a mixture of NaOH/SiO₂; heating the mixture of NaOH/SiO₂; obtaining a sodium silicate (Na₂O)ₓ(SiO₂)_{y}; diluting the sodium silicate (Na₂O)ₓ(SiO₂)_{y} in water producing a sodium silicate diluted solution (Na₂O)ₓ(SiO₂)_{y} and filtering the sodium silicate diluted solution (Na₂O)ₓ(SiO₂)_{y} to remove impurities.

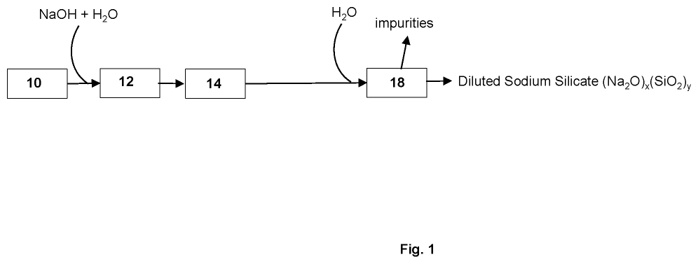

As provided in FIG. 1, the process described herein generally consists in firstly homogenizing 10 residual SiO₂ silica by grinding. Residual SiO₂ silica is grinded down to a size of about 50 μm.

Residual silica can be provided from magnesium extraction processes starting from magnesium silicate ore such as e.g. but not limited from serpentine, as described for example in WO 2016/176772, the content of which is enclosed herewith in its entirety.

The homogenized SiO₂ silica is mixed 12 with NaOH producing a mixture of NaOH/SiO₂ which is then heated 14 for dissolving.

In an embodiment, the homogenized residual SiO₂ silica is pretreated with a mixture of H₂O—NaOH producing a mixture of NaOH/SiO₂. The homogenized SiO₂ silica is mixed with H₂O—NaOH (at a ratio 0.5:1 to 3.5:1 equivalent SiO₂: Na₂O) and the mixture is heated 14. The mixture (which produces a lot of heat) is mixed until apparent homogeneity. The reactor containing the mixture is heated at 80-120° C. for 60-120 min to obtain sodium silicate (Na₂O)ₓ(SiO₂)_{y} solution. The (Na₂O)ₓ(SiO₂)_{y} solution is further diluted in water producing a sodium silicate diluted solution (Na₂O)ₓ(SiO₂)_{y}.

As encompassed herein, the NaOH/SiO₂ mixture is at a mass ratio of 0.5:1 to 3.5:1 equivalent SiO₂: Na₂O.

The sodium silicate diluted solution (Na₂O)ₓ(SiO₂)_{y} obtained is filtered 18 to remove undissolved impurities.

The process described herein provides a means to efficiently produce sodium silicate with a yield as detailed in table 1.

TABLE 1
Yields obtain for the tested process

| | Yields |
|---|---|
| Dissolution of SiO₂ | 85-95% |

Accordingly, it is provided an improved process for the production of sodium silicate which is efficient, uses less energy and is environmental friendly compared to known processes.

While the disclosure has been described with particular reference to the illustrated embodiment, it will be understood that numerous modifications thereto will appear to those skilled in the art. Accordingly, the above description and accompanying drawings should be taken as illustrative and not in a limiting sense.

While the present disclosure has been described in connection with specific embodiments thereof, it will be understood that it is capable of further modifications and this application is intended to cover any variations, uses, or adaptations and including such departures from the present disclosure as come within known or customary practice within the art to which and as may be applied to the essential features hereinbefore set forth, and as follows in the scope of the appended claims.

1. A process for producing sodium silicate comprising the steps of:
a) homogenizing residual SiO₂ silica with NaOH producing a mixture of NaOH/SiO₂;
b) heating the mixture of NaOH/SiO₂; obtaining a sodium silicate (Na₂O)ₓ(SiO₂)_{y};
c) diluting the sodium silicate (Na₂O)ₓ(SiO₂)_{y} in water producing a sodium silicate diluted solution (Na₂O)ₓ(SiO₂)_{y}; and
d) filtering the sodium silicate diluted solution (Na₂O)ₓ(SiO₂)_{y} to remove impurities.

2. The process of claim 1, wherein the sodium silicate is suitable for a precipitated silica process.

3. The process of claim 1 or 2, wherein the homogenizing residual SiO₂ silica is pretreated with a mixture of H₂O—NaOH producing a mixture of NaOH/SiO₂.

4. The process of claim 3, wherein the residual SiO₂ silica is further grinded.

5. The process of claim 4, wherein residual SiO₂ silica is grinded to a size of about 50 μm.

6. The process of any one of claim 1, wherein the homogenized SiO₂ silica is mixed with NaOH in a ratio of 0.5:1 to 3.5:1 equivalent SiO₂: Na₂O.

7. The process of claim 6, wherein the NaOH/SiO₂ mixture is heated at 80-120° C.

8. The process of any one of claim 1, wherein the filtered the sodium silicate diluted solution is further washed with water.

9. The process of any one of claim 1, wherein the mixture of NaOH/SiO₂; is heated in a reactor.

10. The process of any one of claim 1, wherein the residual SiO₂ silica is provided from a magnesium extraction process.

11. The process of claim 10, wherein the residual SiO₂ silica is provided from a magnesium extraction process from serpentine.

12. A process for producing sodium silicate comprising the steps of:
a) isolating residual SiO₂ silica from serpentine;
b) homogenizing the residual SiO₂ silica with NaOH producing a mixture of NaOH/SiO₂;
c) heating the mixture of NaOH/SiO₂; obtaining a sodium silicate (Na₂O)ₓ(SiO₂)_{y};
d) diluting the sodium silicate (Na₂O)ₓ(SiO₂)_{y} in water producing a sodium silicate diluted solution (Na₂O)ₓ(SiO₂)_{y} and
e) filtering the sodium silicate diluted solution (Na₂O)ₓ(SiO₂)_{y} to remove impurities.
